(19) United States
(12) Patent Application Publication
(10) Pub. No.: US 2021/0098793 A1
(43) Pub. Date: Apr. 1, 2021

(54) POWER STORAGE ELEMENT, POWER STORAGE CELL, AND POWER STORAGE AND DISCHARGE SYSTEM

(71) Applicant: TOHOKU UNIVERSITY, Sendai-shi, Miyagi (JP)

(72) Inventors: Tomohide DATE, Sendai-shi, Miyagi (JP); Masato SHIRAKATA, Sendai-shi, Miyagi (JP); Fumihiko HASEGAWA, Sendai-shi, Miyagi (JP); Masaaki HIKICHI, Tagajyo-shi, Miyagi (JP)

(21) Appl. No.: 16/644,580

(22) PCT Filed: Jun. 12, 2019
(86) PCT No.: PCT/JP2019/023319

§ 371 Date: Mar. 5, 2020

(30) Foreign Application Priority Data
Jun. 14, 2018 (JP) PCT/JP2018/022805

(51) Int. Cl. H01M 4/66; H01M 4/36; H01M 4/70; H01M 2/30; H01M 10/0525

(52) U.S. Cl. CPC H01M 4/661; H01M 4/366; H01M 2004/028; H01M 2/30; H01M 10/0525; H01M 4/70

(57) ABSTRACT

A power storage element includes: a cathode which includes a cathode collector and an active material layer; a anode which includes a anode collector and an active material layer; a separator which is interposed between the cathode and the anode; a first terminal which is used for charging and is connected to an outer periphery of the cathode collector; a second terminal which is used for at least one of charging and discharging and is connected to an outer periphery of the anode collector; and a third terminal which is used for discharging and is connected to the outer periphery of one of the cathode collector and the anode collector so as to be separated from the first terminal or the second terminal.

### CROSS-REFERENCE TO RELATED PATENT APPLICATION

This application claims priority to international patent application No. PCT/JP2018/022805, filed Jun. 14, 2018, which is incorporated herein by reference in its entity.

### TECHNICAL FIELD

The present invention relates to a power storage element, a power storage cell, and a power storage and discharge system.

### BACKGROUND OF THE INVENTION

In power generation using natural energy such as solar power, wind power, and tidal current/tidal power, a variation in generated power inevitably occurs due to environmental changes. When using such generated power, a voltage stabilizing circuit is provided to stabilize generated power to be output.

Meanwhile, for example, when the time is night, the sky is cloudy, or the atmosphere is calm without wind, it is difficult to generate power using natural energy. For that reason, excessive power is stored in a power storage cell when power generation is possible and the stored excessive power is used when power generation is not possible. For example, Patent Literatures 1 and 2 disclose an outdoor monitoring device which stores generated power of a solar cell in a power storage cell, uses the generated power as driving power of a device such as an imaging camera, and monitors an obtained captured image.

In addition, a power supply system which combines power generation using natural energy and power storage and enables power supply for 24 hours regardless of whether power is generated or not has been proposed. This power supply system is used for lighting in a tunnel, purifying air, and the like. Incidentally, in such a system, it is necessary to provide a power storage cell and a switching circuit for switching power supply in addition to a voltage stabilization circuit. Such a system is expensive. The need for the voltage stabilization circuit is not limited to power generation using natural energy. For example, the same applies to a case in which an output value (power generation voltage) intentionally varies as in dynamo power generation.

### LISTING OF CITATIONS

Patent Document 1: Japanese Patent Application Laid-Open No. 2008-98854.
Patent Document 2: Japanese Patent Application Laid-Open No. 2015-64800.

### SUMMARY OF THE INVENTION

### Technical Problems

The power stored in a power storage cell is used after the power has been charged to a certain amount. This is because a discharging voltage (output voltage) varies due to a variation of a charging voltage if the power is used (discharged) in a charging state. If power obtained from natural energy is stored in a power storage cell and is discharged at the same time, the terminals are shared for charging and discharging. As a result, the discharging voltage varies due to the variation of the charging voltage (power generation voltage).

FIG. 15 shows a configuration example of a lithium ion power storage element A according to a comparative example. The lithium ion power storage element A includes a cathode collector 1 which has a cathode active material layer 2 formed on both surfaces thereof, an anode collector 4 which has an anode active material layer 5 formed on both surfaces thereof, and a separator 7. The cathode collector 1 and the cathode active material layer 2 constitute a cathode and the anode collector 4 and the anode active material layer 5 constitute an anode. In the lithium ion power storage element A, the cathode and the anode are laminated with the separator 7 interposed therebetween. A cathode 3 is provided in a left end of an end portion region not provided with the cathode active material layer 2 in the cathode collector 1 and an anode 6 is provided in a right end of an end portion region not provided with the anode active material layer 5 in the anode collector 4. FIG. 16 is a diagram schematically showing a configuration when viewed from the anode after the cathode, the separator, and the anode are overlapped. A plurality of the lithium ion power storage elements A are overlapped with the separator interposed therebetween. The overlapped elements are stored in a battery container along with an electrolyte and are sealed, thereby manufacturing the power storage cell.

The cathode 3 is connected to a load 9 and a power supply 8 such as a power generator and the anode 6 is connected to a changeover switch 10. Two terminals of the switch 10 are respectively connected to the power supply 8 and the load 9. When the switch 10 is connected to the power supply 8, the power storage element A is charged by the power of the power supply 8. Then, when the switch 10 is connected to the load 9, the power is discharged from the power storage element A and is supplied to the load 9.

The power storage element A according to the comparative example is configured to be switched between charging and discharging by the switch 10. When the switch 10 is omitted and the charging and discharging are performed at the same time, the load 9 is directly affected by a variation of the power of the power supply 8.

The present invention has been made in view of the above-described circumstances and an object of the present invention is to provide a power storage element capable of performing a discharging operation while suppressing a voltage variation even in a charging state with a simple configuration not requiring a large increase in cost and a power storage cell using the same.

### Solution to Problems

(1). A power storage element according to a first aspect includes: a cathode which includes a cathode collector and an active material layer formed on a surface of the cathode collector; an anode which includes an anode collector and an active material layer formed on a surface of the anode collector; a separator which is interposed between the cathode and the anode; a first terminal which is used for charging and is connected to an outer periphery of the cathode collector; a second terminal which is used for at least one of charging and discharging and is connected to an outer periphery of the anode collector; and a third terminal which is used for discharging and is connected to an outer periphery of one of the cathode collector and the anode collector so as to be separated from the first terminal or the second terminal.

(2). In the power storage element according to the above-described aspect, each of the cathode collector and the anode collector may have a rectangular main surface and the third terminal may be connected to a side of the cathode collector or the anode collector, the side being different from a side with the first terminal or the second terminal of the cathode collector or the anode collector that the third terminal is connected to.

(3). In the power storage element according to the above-described aspect, the third terminal may be separated by a predetermined distance or more from the first terminal or the second terminal connected to the cathode collector or the anode collector to which the third terminal is connected and if a resistance of a region provided with the active material layer is denoted by R1 and a resistance of a region not provided with the active material layer is denoted by R1′ when the active material layer between two terminals is peeled off by a width of 0.1 mm, the predetermined distance may be a distance in which a ratio of R1/R1′ is 1 or less.

(4). In the power storage element according to the above-described aspect, the third terminal may be connected to an outer periphery of one of the cathode collector and the anode collector, a fourth terminal may be connected to an outer periphery of the other thereof, and the fourth terminal may not overlap the first terminal, the second terminal, and the third terminal when viewed from a lamination direction.

(5). In the power storage element according to the above-described aspect, the fourth terminal may be separated by a predetermined distance or more from the first terminal or the second terminal connected to the cathode collector or the anode collector to which the fourth terminal is connected and if a resistance of a region provided with the active material layer is denoted by R2 and a resistance of a region not provided with the active material layer is denoted by R2′ when the active material layer between two terminals is peeled off by a width of 0.1 mm, the predetermined distance may be a distance in which a ratio R2/R2′ is 1 or less.

(6). A power storage cell according to a second aspect stores a plurality of the power storage elements according to the above-described aspect in a battery container along with an electrolyte and each of a plurality of the first terminals, a plurality of the second terminals, and a plurality of the third terminals forms a group and is drawn to the outside of the battery container.

(7). A power storage cell according to a second aspect stores a plurality of the power storage elements according to the above-described aspect in a battery container along with an electrolyte and each of a plurality of the first terminals, a plurality of the second terminals, a plurality of the third terminals, and a plurality of the fourth elements forms a group and is drawn to the outside of the battery container.

(8). A storage power generation system according to a second aspect includes: the power storage element according to the above-described aspect; and a power supply which is connected to the power storage element and of which an output value varies, the first external terminal and the second external terminal of the power storage element are connected to the power supply, and the second external terminal and the third external terminal of the power storage element are connected to a load.

### Advantages of the Invention

Since the power storage element and the storage power generation system according to an aspect of the present invention have a simple configuration which does not require a significant increase in cost, it is possible to perform discharging while suppressing a voltage variation even in a charging state.

### BRIEF DESCRIPTION OF DRAWINGS

FIG. 1 is a diagram in which a cathode and an anode are arranged after being extracted from a power storage element according to a first embodiment.

FIG. 2 is a diagram schematically showing a configuration of the power storage element according to the first embodiment.

FIG. 3A is a diagram schematically showing a configuration of a power storage cell including the power storage element of FIG. 2.

FIG. 3B is a diagram schematically showing a configuration of the power storage cell including the power storage element of FIG. 2.

FIG. 4 is a diagram in which a cathode and an anode are arranged after being extracted from a power storage element according to a second embodiment.

FIG. 5 is a diagram schematically showing a configuration of the power storage element according to the second embodiment.

FIG. 6 is a diagram in which a cathode and an anode are arranged after being extracted from a power storage element according to a third embodiment.

FIG. 7 is a diagram schematically showing a configuration of the power storage element according to the third embodiment.

FIG. 8 is a diagram in which a cathode and an anode are arranged after being extracted from a power storage element according to a fourth embodiment.

FIG. 9 is a diagram schematically showing a configuration of the power storage element according to the fourth embodiment.

FIG. 10 is a diagram in which a cathode and an anode are arranged after being extracted from a power storage element according to a fifth embodiment.

FIG. 11 is a diagram schematically showing a configuration of the power storage element according to the fifth embodiment.

FIG. 12 is a diagram schematically showing a configuration of a power storage cell including the power storage element of FIG. 11.

FIG. 13 is a diagram in which a cathode and an anode are arranged after being extracted from a power storage element according to a sixth embodiment.

FIG. 14 is a diagram schematically showing a configuration of the power storage element according to the sixth embodiment.

FIG. 15 is a diagram in which a cathode and an anode are arranged after being extracted from a power storage element according to a comparative example.

FIG. 16 is a diagram schematically showing a configuration of the power storage element according to the comparative example.

FIG. 17 is a schematic diagram of a storage power generation system according to Example 1.

FIG. 18 is a voltage waveform output from a power supply.

FIG. 19 is a graph obtained by measuring a voltage output to a load in Example 1.

FIG. 20 is a schematic diagram of a storage power generation system according to Comparative Example 1.

FIG. 21 is a graph obtained by measuring a voltage output to a load in Comparative example 1.

FIG. 22 is a graph obtained by measuring a voltage output to a load when a resistance value of a power storage cell is higher than that of Comparative Example 1.

FIG. 23 is a graph obtained by measuring a voltage output to a load in Comparative Example 2.

FIG. 24 is a graph obtained by measuring a voltage output to a load 9 when a resistance value of a power storage cell is higher than that of Comparative Example 2.

### DESCRIPTION OF EMBODIMENTS OF THE INVENTION

Hereinafter, a power storage element according to an embodiment will be described in detail with reference to the drawings. Additionally, in the drawings used in the following description, the characteristic portions may be enlarged for convenience of description in order to easily understand the features and the dimensional ratios of the components are not always the same as the actual ones. Further, the materials, dimensions, and the like exemplified in the following description are merely examples and the present invention is not limited thereto and can be implemented with appropriate changes within a scope that does not change the gist of the present invention.

### First Embodiment

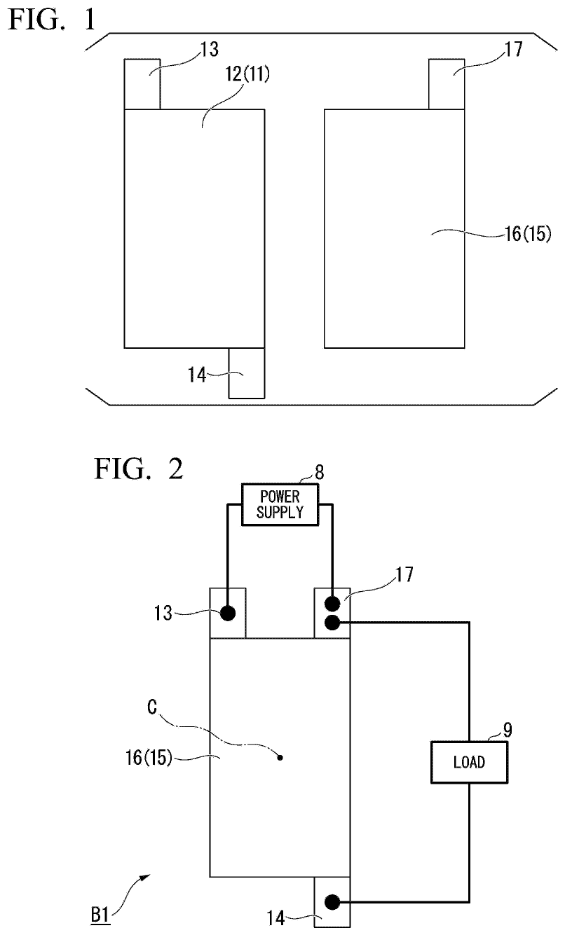

FIG. 1 is a diagram in which a cathode (a left side) and an anode (a right side) are arranged after being extracted from a power storage element B1 according to a first embodiment. FIG. 2 is a diagram schematically showing a configuration of the power storage element B1 assembled as an example assuming an application case to a lithium-ion battery element.

The power storage element B1 includes a cathode collector 11 and an anode collector 15 which are arranged in the thickness direction and have a sheet shape, a separator (not shown) which is interposed between the cathode collector 11 and the anode collector 15, and three terminals (a first terminal 13, a second terminal 17, and a third terminal 14).

The cathode includes the cathode collector 11 and the cathode active material layer 12. The anode includes the anode collector 15 and the anode active material layer 16. The cathode active material layer 12 and the anode active material layer 16 are respectively formed on the surfaces (preferably, the entire main surfaces) of the cathode collector 11 and the anode collector 15.

The first terminal (the cathode) 13 is connected to the outer periphery (here, the left upper end portion) of the cathode collector 11. The second terminal (the anode) 17 is connected to the outer periphery (the right upper end portion) of the anode collector 15. The third terminal 14 is connected to the outer periphery (here, the right lower end portion of the cathode collector 11) of one of the cathode collector 11 and the anode collector 15.

The first terminal 13, the second terminal 17, and the third terminal 14 are provided so as not to overlap each other when viewed from above the cathode collector 11 and the anode collector 15 in the thickness direction. The third terminal 14 is connected so as to be separated from the first terminal 13 connected to the cathode collector 11 to which the third terminal 14 is connected. The third terminal 14 and the first terminal 13 are connected to, for example, the different sides of the cathode collector 11. The third terminal 14 is preferably disposed so as to be axially symmetric to the first terminal 13 or the second terminal 17 around a center axis C connecting the centers of the cathode collector 11 and the anode collector 15 when viewed from above in the thickness direction.

As an active material forming the cathode active material layer 12, it is preferable to use a material of which a crystal structure does not change depending on the lithium ion content. For example, in a spinel structure, an olivine structure, and a perovskite structure, a crystal structure is not changed by the lithium ion content. An active material of which a crystal structure does not change depending on the content of lithium ions maintains its crystal structure even during overcharge or over-discharge and has high safety. Further, the active material forming the anode active material layer 16 is preferably a carbon material such as carbon or graphite or LTO (lithium titanium oxide Li₄Ti₅O₁₂) having a spinel structure. These materials are unlikely to emit smoke or combust even when the battery is in an overvoltage state.

In the power storage element B1 shown in FIG. 2, the first terminal 13 and the second terminal 17 are connected to a power supply 8 such as power generator without a changeover switch. Further, in the power storage element B1, the second terminal 17 and the third terminal 14 are connected to the load 9 without a changeover switch. That is, the power storage element B1 realizes a state in which both a charging circuit to which the power supply 8 is connected and a discharging circuit to which the load 9 is connected are simultaneously turned on. Thus, the power storage element B1 can perform discharging (power feeding) to the load 9 through the anode 17 and the third terminal 14 at the same time while being charged through the cathode 13 and the anode 17 by the power supply 8. The first terminal 13 is used for charging, the second terminal 17 is used for charging and discharging, and the third terminal 14 is used for discharging.

In the power storage element B1, the supply voltage (the discharging voltage) to the load 9 is stably maintained even when the supply voltage (the charging voltage) of the power supply 8 varies. This is because the active material layer (here, the cathode active material layer 12) is interposed between the first terminal 13 and the third terminal 14 and a voltage variation is attenuated in the active material layer.

The potential of the cathode of the power storage element B1 varies depending on the content of conductive ions (lithium ions) contained in the cathode active material layer 12. That is, the potential of the cathode of the power storage element B1 is limited by the movement amount of the conductive ions regardless of the charging voltage from the outside. That is, even when the charging voltage at the first terminal 13 varies, the voltage variation is attenuated while being propagated through the movement of the conductive ions in the cathode active material layer 12. As a result, the voltage variation reaching the third terminal 14 is suppressed so that the discharging voltage becomes constant.

Further, the potential of the cathodes and anodes depends on a difference between the impedance of the power storage element B1 and the impedance of the power supply 8. It is preferable that the impedance of the power supply 8 is higher than the impedance of the power storage element B1. A variation amount of the charging voltage supplied through a thin wire is reduced in the power storage element B1 having a sufficiently wide region.

In the embodiment, independent (separate) terminals are provided for charge input (charging) and charge output (discharging). For that reason, the varying voltage and current input at the terminal for charge input are reduced when lithium ions in the active material layer move to the anode. As a result, independent terminals for charge output are configured to output a constant voltage not affected by varying voltage and current. With this structure, even when the generated current is small, charging can be performed from the input terminal and a current with very little voltage variation can be supplied from the output terminal.

In the power storage element B1, a potential difference between the cathode and the anode changes depending on the state of charge. The change range of the potential difference depends on the type of active material to be used. For example, when lithium manganate is used in the cathode and graphite is used in the anode, the change range of the potential difference is substantially 3 V to 4.2 V. When the initial inter-terminal voltage is 3V and a voltage of 3.5V is applied to the input terminal, the storage element B1 is slowly charged and the output terminal voltage slowly increases from 3V to 3.5V. Finally, the voltage becomes constant at 3.5V. In the power storage element B1 using lithium manganate in the cathode, since the crystal structure is stable, the same amount of the current as the input current can be output from the output terminal.

The shape of the main surface of each of the cathode collector 11 and the anode collector 15 is, for example, a rectangular shape. The main surface is a surface on which the cathode collector 11 and the anode collector 15 extend. When the battery is wound, the extended surfaces of the cathode collector 11 and the anode collector 15 become main surfaces. It is preferable that the cathode collector 11 and the anode collector 15 have substantially the same area. Further, it is preferable that the first terminal 13, the second terminal 17, and the third terminal 14 are separated from each other when the main surfaces are viewed from above. For example, as shown in FIGS. 1 and 2, when the main surfaces of the cathode collector 11 and the anode collector 15 are rectangular, it is preferable that the first terminal 13 and the second terminal 17 are connected to a side different from the installation side of the third terminal 14 among four sides forming a rectangular shape.

FIGS. 1 and 2 show a case in which the first terminal 13 and the third terminal 14 are respectively provided in the vicinity of two diagonal vertexes on the rectangular main surface of the cathode collector 11. However, the first terminal 13 and the third terminal 14 may not overlap each other when viewed from above in a direction perpendicular to the main surface. For example, these terminals may be provided in the vicinity of two apexes on the same side of the rectangular main surface of the cathode collector 11.

In the embodiment, a case in which the third terminal 14 is connected to the outer periphery of the cathode collector 11 is shown, but the third terminal 14 may be connected to the outer periphery of the anode collector 15. In that case, the first terminal 13 and the second terminal 17 are connected to the power supply 8 and the first terminal 13 and the third terminal 14 are connected to the load 9. However, the limitation of the positional relationship between the first terminal 13 and the third terminal 14 is the same as the case in which the terminals are connected to the outer periphery of the cathode collector 11.

The power storage cell stores a required number (a plurality) of power storage elements B1 in a battery container along with an electrolyte solution or a solid electrolyte according to a required capacity. The power storage cell is formed by sealing the battery container. The plurality of first terminals 13, the plurality of second terminals 17, and the plurality of third terminals 14 respectively form a group and a part of them respectively become a first external terminal, a second external terminal, and a third external terminal. The first external terminal, the second external terminal, and the third external terminal are parts drawn to the outside of the battery container. The first external terminal, the second external terminal, and the third external terminal are, for example, the distal end portions drawn to the outside of the battery container in the first terminal 13, the second terminal 17, and the third terminal 14. The first external terminal, the second external terminal and the third external terminal are respectively different external terminals and connect the power storage element to the outside.

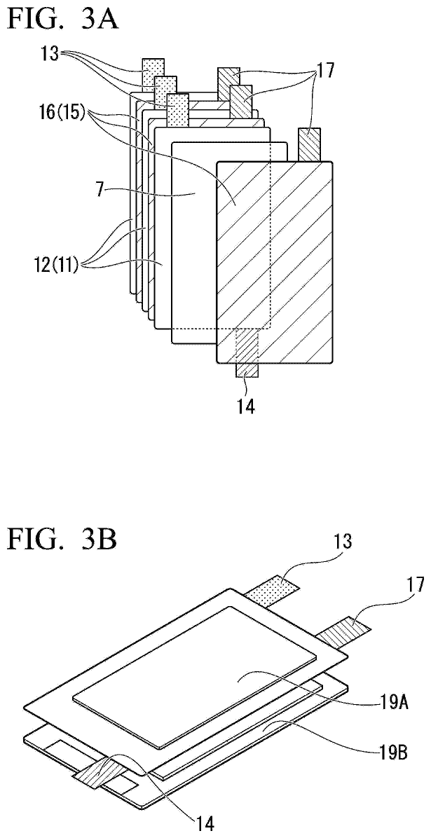

FIGS. 3A and 3B are respectively exploded views schematically showing a configuration example of a laminate type power storage cell including the power storage element B1 of FIG. 2. In FIG. 3A, the layers of the cathode collector 11, the anode collector 15, and the separator 7 constituting the laminate type power storage cell are separated and arranged in a lamination order. In FIG. 3B, the layers of laminate films 19A and 19B constituting the laminate type power storage cell are separated and arranged.

As shown in FIG. 3A, in the power storage element B1, a plurality of cathodes and an anodes are alternately laminated with the separator 7 interposed therebetween. The uppermost and lowermost layers of the laminated power storage element B1 are covered with the laminate films 19A and 19B made of aluminum and shown in FIG. 3B and are stored in the battery container along with an electrolyte solution. The laminate type power storage cell can be obtained by sealing the battery container.

As described above, in the power storage element B1 according to the embodiment, a charging circuit and a discharging circuit are separately formed by a simple configuration in which three terminals are provided. Since the active material layer is interposed between two circuits, even when the voltage input from the charging circuit varies, the effect of the variation on the output voltage in the discharging circuit can be suppressed to a low level due to the rectifying action in the active material layer. Thus, since the power storage element B1 according to the embodiment and the power storage cell using the same have a simple configuration which does not require a significant increase in cost, it is possible to perform stable discharging while suppressing a voltage variation even in the charging state.

For example, when the power storage element B1 and the power storage cell according to the embodiment are applied to a power supply system (a storage discharge system) that combines power generation and power storage in which an output value varies, a voltage stabilizing circuit and a switching circuit for switching power supply are not required. Accordingly, the system can be configured at low cost.

Additionally, the power storage element B1 and the power storage cell according to the embodiment do not exclude the use of a converter and an inverter for adjusting the generated voltage to a desired voltage. Further, the power storage target is not limited to renewable energy power generation such as solar power generation, wind power generation, and tidal current/tidal power generation, but any power source with a varying supply voltage is included. A dynamo generator is an example of a power supply of which a supply voltage varies.

### Second Embodiment

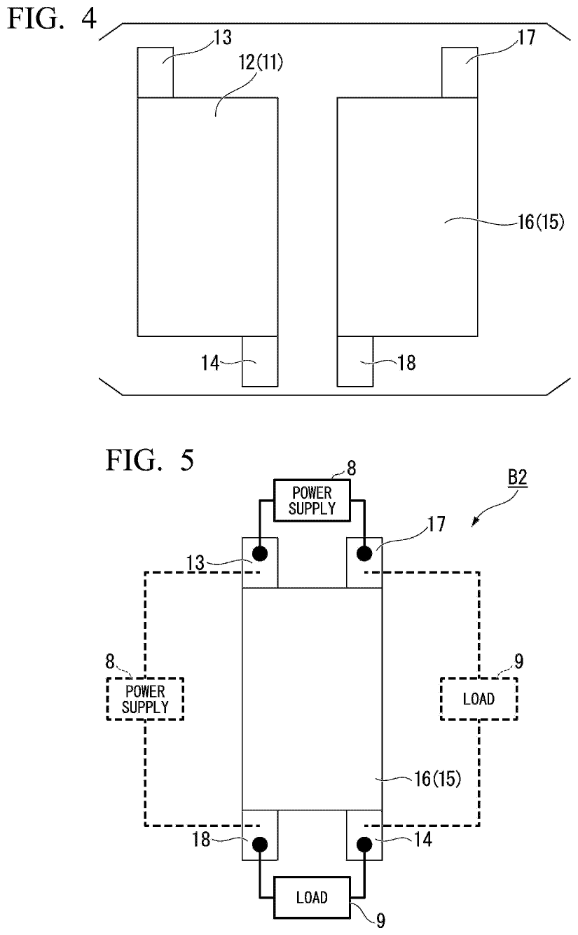

FIG. 4 is a diagram in which a cathode (a left side) and an anode (a right side) are arranged after being extracted from a power storage element B2 according to a second embodiment. FIG. 5 is a diagram schematically showing a configuration of the power storage element B2 assembled as an example assuming an application case to a lithium-ion battery element.

In the embodiment, the third terminal 14 is connected to the outer periphery of one of the cathode collector 11 and the anode collector 15 and a fourth terminal 18 is connected to the outer periphery of the other thereof. When viewed from above the cathode collector 11 and the anode collector 15 in the thickness direction, the fourth terminal 18 is provided so as not to overlap the first terminal 13, the second terminal 17, and the third terminal 14. The fourth terminal 18 is separated from the second terminal 17 connected to the anode collector 15 to which the fourth terminal 18 is connected.

Other configurations are the same as those of the first embodiment and the portions corresponding to the first embodiment are denoted by the same reference numerals regardless of a difference in shape. In the embodiment, at least the same effects as in the first embodiment can be obtained.

FIGS. 4 and 5 show a case in which the first terminal 13, the second terminal 17, the third terminal 14, and the fourth terminal 18 are respectively connected in the vicinity of four apexes of the rectangular main surface of the cathode collector 11 or the anode collector 15. The first terminal 13 and the third terminal 14 are respectively connected in the vicinity of two diagonal vertexes on the rectangular main surface of the cathode collector 11. The second terminal 17 and the fourth terminal 18 are respectively connected in the vicinity of two diagonal vertexes of the rectangular main surface of the anode collector 15. The first terminal 13 and the second terminal 17 are connected to the power supply 8 and the third terminal 14 and the fourth terminal 18 are connected to the load 9. The first terminal 13 and the second terminal 17 are used for charging and the third terminal 14 and the fourth terminal 18 are used for discharging.

Additionally, the first terminal 13, the second terminal 17, the third terminal 14, and the fourth terminal 18 may not overlap each other when viewed from above in a direction perpendicular to the main surface and the present invention is not limited to the arrangement of FIGS. 4 and 5.

FIG. 5 shows two types of circuits for connecting the power supply 8 and the load 9. In the circuit indicated by a solid line, the first terminal 13 and the second terminal 17 are connected to the power supply 8 and the third terminal 14 and the fourth terminal 18 are connected to the load 9. In this case, the first terminal 13 and the second terminal 17 are used for charging and the third terminal 14 and the fourth terminal 18 are used for discharging. In the circuit indicated by a dashed line, the first terminal 13 and the fourth terminal 18 are connected to the power supply 8 and the third terminal 14 and the second terminal 17 are connected to the load 9. In this case, the first terminal 13 and the fourth terminal 18 are used for charging and the third terminal 14 and the second terminal 17 are used for discharging. Even when any circuit is used, the same effects can be obtained.

In the first embodiment, one of the two terminals connected to the power supply 8 is a terminal common to one of the two terminals connected to the load 9. In contrast, in the embodiment, the two terminals connected to the power supply 8 and the two terminals connected to the load 9 are completely separate terminals, so that the influence of the power variation of the power supply 8 on the load 9 can be further suppressed.

The power storage cell is formed by storing a required number (a plurality) of power storage elements B2 in a battery container along with an electrolyte solution or a solid electrolyte and sealing the battery container according to the required capacity. The plurality of first terminals 13, the plurality of second terminals 17, the plurality of third terminals 14, and the plurality of fourth terminals 18 respectively form a group and a part of them respectively become a first external terminal, a second external terminal, a third external terminal, and a fourth external terminal. The fourth external terminal is a part of the plurality of fourth terminals 18 and is a distal end portion drawn to the outside of the battery container. The fourth external terminal is an external terminal different from the first external terminal, the second external terminal, and the third external terminal and connects the power storage element to the outside.

### Third Embodiment

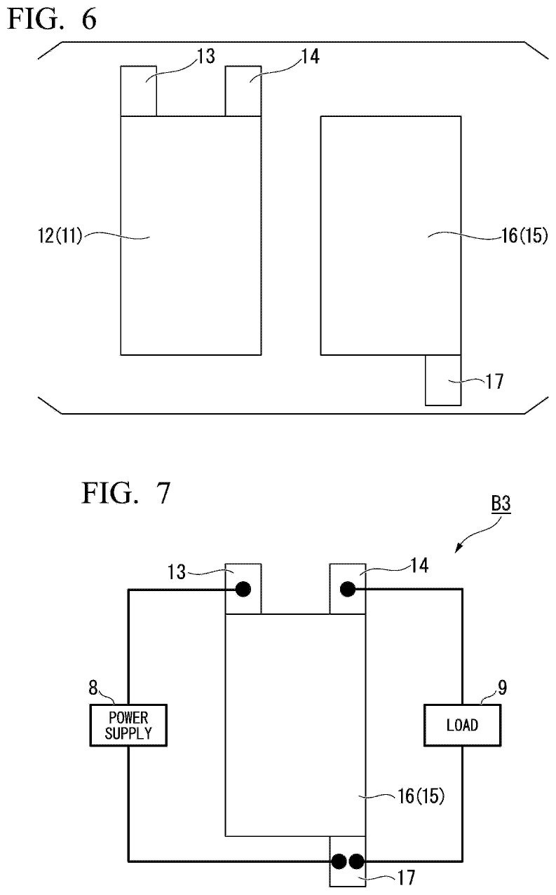

FIG. 6 is a diagram in which a cathode (a left side) and an anode (a right side) are arranged after being extracted from a power storage element B3 according to a third embodiment of the present invention. FIG. 7 is a diagram schematically showing a configuration of the power storage element B3 assembled as an example assuming an application case to a lithium-ion battery element.

In the embodiment, the cathode collector 11 and the anode collector 15 have a rectangular main surface and the third terminal 14 is provided on the same side as the side in which the first terminal 13 is provided or the side in which the second terminal 17 is provided among four sides forming a rectangular shape. FIGS. 6 and 7 show a case in which the first terminal 13 is connected to one end (left end) of the same side (upper side) and the third terminal 14 is connected to the other end (right end) thereof in the outer periphery of the cathode collector 11.

Other configurations are the same as those of the first embodiment and the portions corresponding to the first embodiment are denoted by the same reference numerals regardless of a difference in shape. In the embodiment, at least the same effects as in the first embodiment can be obtained.

When the noise absorption capacity of the active material layer is reduced due to the occurrence of peeling or the like, the influence of the power variation (noise current) of the power supply 8 on the load 9 may occur if the distance between the input terminal (the first terminal 13 or the second terminal 17) and the output terminal (the third terminal 14) is short. In order to further stabilize the discharging voltage of the active material layer by attenuating the noise level, it is preferable that the input terminal and the output terminal are provided so as to be sufficiently separated from each other.

It is preferable that a suitable distance between the input terminal and the output terminal is a predetermined distance or more. When the input terminal and the output terminal are formed on the same side, the active material layer between them may peel off. It is preferable that power variation (noise current) can be sufficiently suppressed even when the active material layer is peeled off.

The noise absorption capacity is determined by a ratio R1/R1′ of a resistance R1 in a region in which the active material layer is formed between the terminals and a resistance R1′ in a region (an active material layer non-formation region) in which the active material layer is not formed. The resistance R1 is a combined resistance of the internal resistance of the active material layer and the internal resistance of the collector (metal). The resistance R1′ is obtained by ρ′×L′/A′. Here, ρ′ is a specific resistance of the collector (the cathode collector 11 or the anode collector 15), L′ is a length between terminals passing through the exposed collector after the active material layer is peeled off, and A is a cross-sectional area of the exposed collector. A varies according to the exposure width of the active material layer.

When the active material layer is interposed in the propagation of the input current, the amount of current flowing in the active material layer is preferably increased. The resistance R1 of the active material layer formation region needs to be larger than the resistance R1′ of the active material layer non-formation region. Here, even when the active material layer between two terminals is peeled off by a width of 0.1 mm, a ratio R1/R1′ between the resistance R1 and the resistance R1′ is preferably 1 or less and more preferably 0.2 or less. Additionally, the peeling width of the active material herein means a width in a direction orthogonal to the connection side of two terminals.

For example, when the collector is made of aluminum (having volume resistivity of 2.8 μΩcm), the thickness of the collector is 20 μm, the number of the cathodes and anodes (the total number of cathodes and anodes) is 30, and the width of the active material layer non-formation region between the input and output terminals is 1 mm, the resistance between the input and output terminals is 4.7 mΩ and the noise level is attenuated to about 30%. When the width of the active material layer non-formation region is 2 mm, the noise level is attenuated to about 20%. When the width of the active material layer non-formation region is 4 mm, the noise level is attenuated to about 10%.

Additionally, even when the fourth terminal 18 is provided on the same side as the installation side of the first terminal 13 or the installation side of the second terminal 17, a ratio R2/R2′ can be defined as in the case of the third terminal 14. R2/R2′ is preferably 1 or less and more preferably 0.2 or less. Here, R2 is the resistance of the region provided with the active material layer between the terminals and R2′ is the resistance of the region (the active material layer non-formation region) not provided with the active material layer.

### Fourth Embodiment

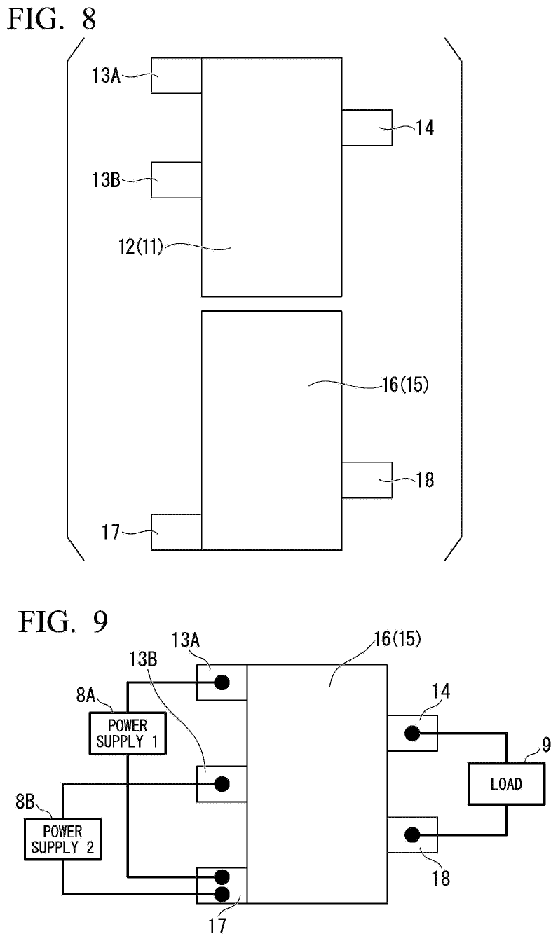

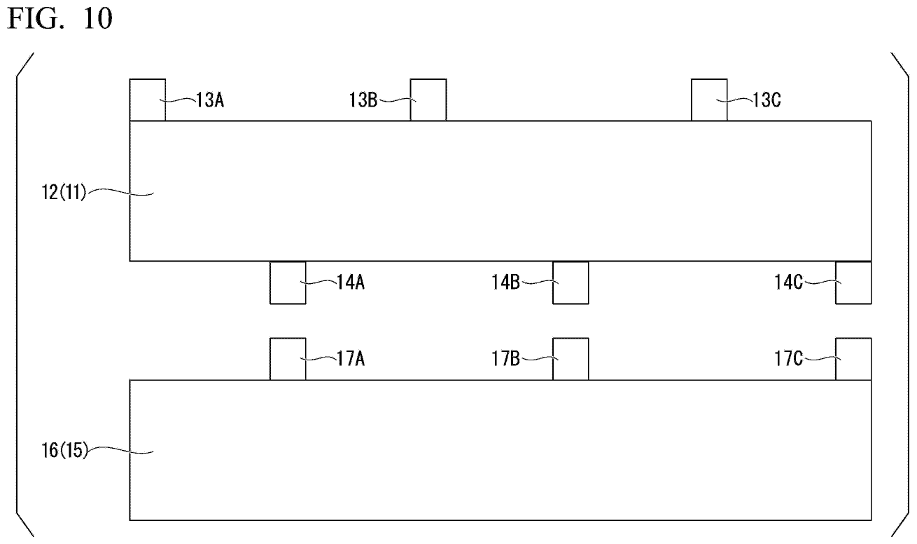

FIG. 8 is a diagram in which a cathode (an upper side) and an anode (a lower side) are arranged after being extracted from a power storage element B4 according to a fourth embodiment. FIG. 9 is a diagram schematically showing a configuration of the power storage element B4 assembled as an example assuming an application case to a lithium-ion battery element.

In the embodiment, a plurality of (here, two) first terminals 13A and 13B connected to the power supply and one third terminal 14 connected to the load are connected to the outer periphery of the cathode collector 11. Then, the second terminal 17 connected to the power supply and the fourth terminal 18 connected to the load are connected to the outer periphery of the anode collector 15. Here, a case is shown in which the cathode collector 11 has a rectangular main surface, the first terminals 13A and 13B are provided in one side portion among four sides forming a rectangular shape, and the third terminal 14 is provided in the other side portion. Further, a case is shown in which the anode collector 15 has a rectangular main surface, the second terminal 17 is provided in one side portion among four sides forming a rectangular shape, and the fourth terminal 18 is provided in the other side portion.

The first terminal 13A and the second terminal 17 are connected to the first power supply 8A, the first terminal 13B and the second terminal 17 are connected to the second power supply 8B, and the third terminal 14 and the fourth terminal 18 are connected to the load 9. The first terminals 13A and 13B and the second terminal 17 are used for charging and the third terminal 14 and the fourth terminal 18 are used for discharging.

As shown in FIG. 9, when viewed from above the cathode collector 11 and the anode collector 15 in the thickness direction, the third terminal 14 is provided so as not to overlap the first terminals 13A and 13B, the second terminal 17, and the fourth terminal 18.

Other configurations are the same as those of the first embodiment and the portions corresponding to the first embodiment are denoted by the same reference numerals regardless of a difference in shape. In the embodiment, at least the same effects as in the first embodiment can be obtained.

### Fifth Embodiment

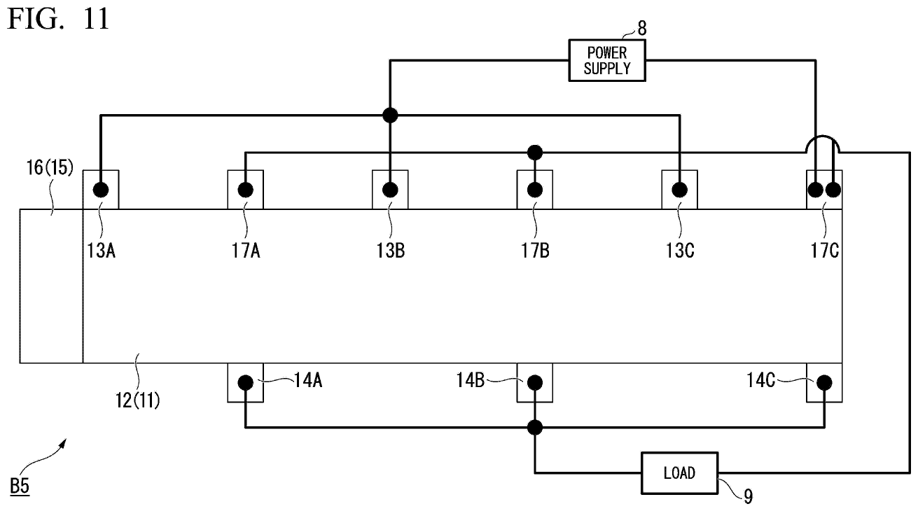

FIG. 10 is a diagram in which a cathode (an upper side) and an anode (a lower side) are arranged after being extracted from a power storage element B5 according to a fifth embodiment. FIG. 11 is a diagram schematically showing a configuration of the power storage element B5 assembled as an example assuming an application case to a cylindrical lithium-ion battery element.

In the embodiment, a plurality of (here, three) first terminals 13A, 13B, and 13C connected to the power supply and a plurality of (here, three) third terminals 14A, 14B, and 14C connected to the load are connected to the outer periphery of the cathode collector 11. Then, a plurality of (here, three) second terminals 17A, 17B, and 17C are connected to the outer periphery of the anode collector 15. Here, a case is shown in which the cathode collector 11 has a rectangular main surface, the first terminals 13A, 13B, and 13C are provided in one side portion among four sides forming a rectangular shape, and the third terminals 14A, 14B, and 14C are provided in the other side portion. Further, a case is shown in which the anode collector 15 has a rectangular main surface and the second terminals 17A, 17B, and 17C are provided in one side portion among four sides forming a rectangular shape.

The first terminals 13A, 13B, and 13C are connected in parallel to one end of the power supply 8 and the second terminals 17A, 17B, and 17C are connected in parallel to the other end of the power supply 8. Further, the third terminals 14A, 14B, and 14C are connected in parallel to one end of the load 9 and the second terminals 17A, 17B, and 17C are connected in parallel to the other end of the load. Additionally, the third terminals 14A, 14B, and 14C may be provided in the anode collector 15. In that case, the first terminals 13A, 13B, and 13C are connected in parallel to the other end of the load.

As shown in FIG. 11, when viewed from above the cathode collector 11 and the anode collector 15 in the thickness direction, the third terminals 14A, 14B, and 14C are provided so as not to overlap the first terminals 13A, 13B, and 13C and the second terminals 17A, 17B, and 17C.

Other configurations are the same as those of the first embodiment and the portions corresponding to the first embodiment are denoted by the same reference numerals regardless of a difference in shape. In the embodiment, at least the same effects as in the first embodiment can be obtained.

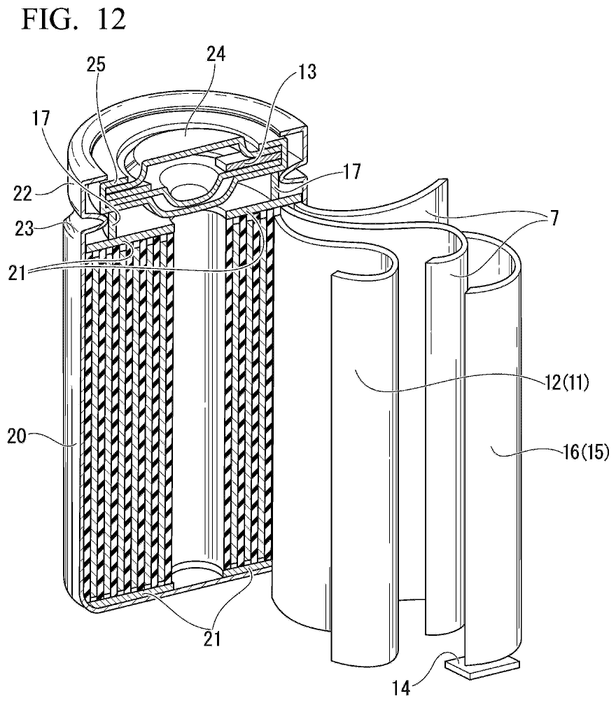

FIG. 12 is a diagram schematically showing a configuration of a cylindrical power storage cell including the power storage element B5 of FIG. 11. The cylindrical power storage cell is wound in a roll shape so that the inside is the cathode collector 11 and the outside is the anode collector 15. The outermost periphery of the wound body is protected by the separator 7. Both ends of the wound body in the winding axis direction are sandwiched between insulators 21. These are stored in a cylindrical metal container 20.

The first terminal 13 (13A, 13B, 13C) is connected to a cathode cap 24 attached to a ring-shaped connector 22 provided in an upper portion of the metal container 20 through an insulation ring 25. The second terminal 14 is connected to a bottom portion of the metal container 20. The third terminal 17 (17A, 17B, 17C) is connected to the ring-shaped connector 22 attached through the insulation ring 23 provided in the upper edge of the metal container 20.

### Sixth Embodiment

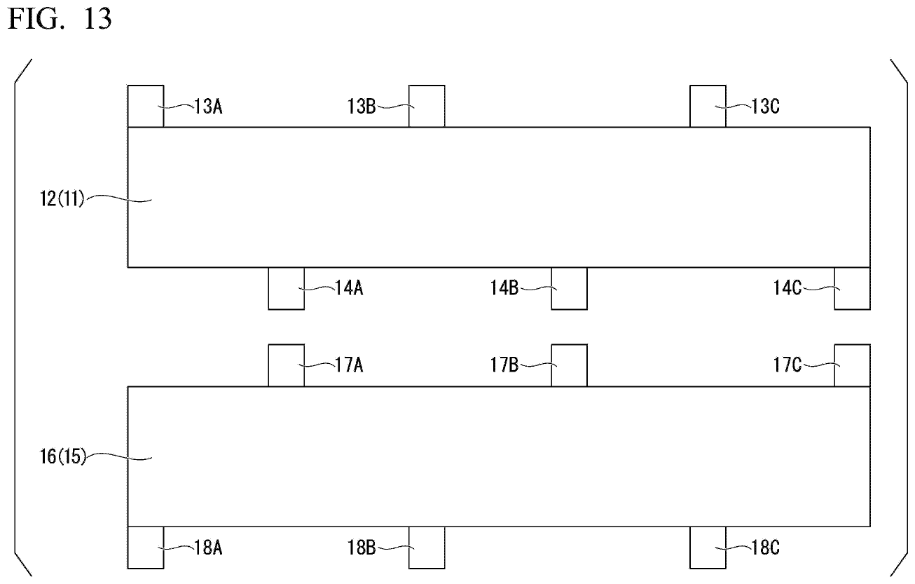

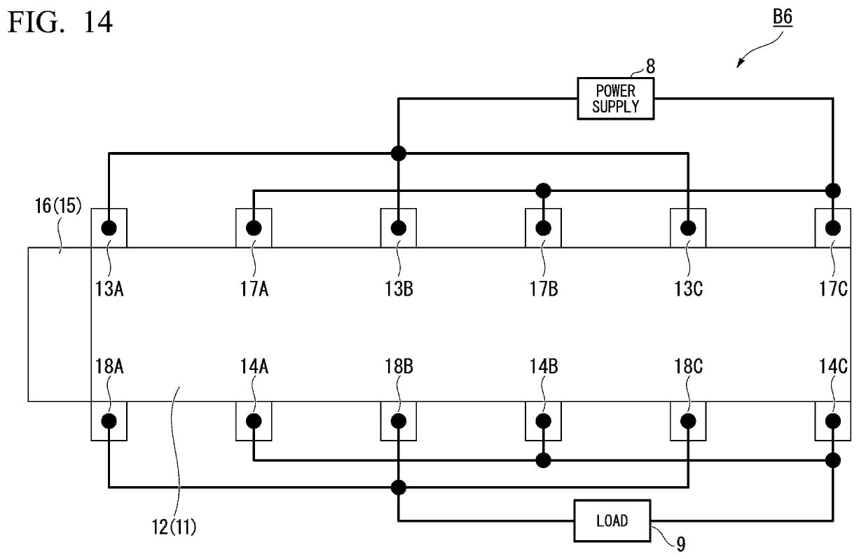

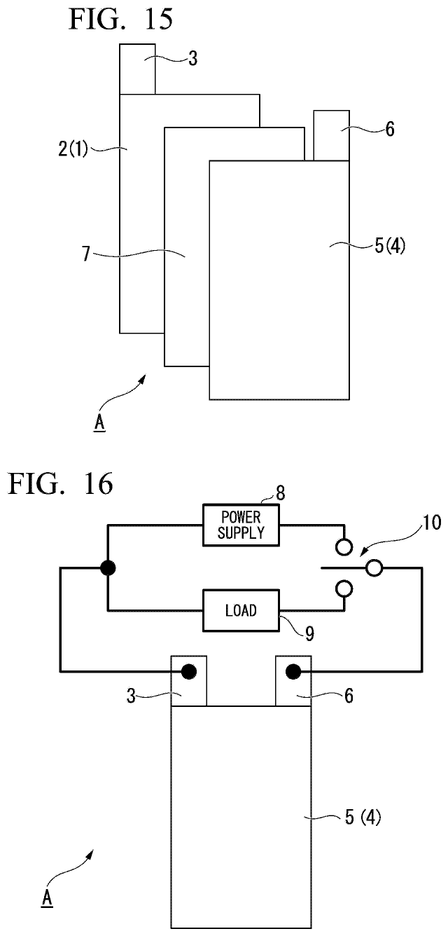

FIG. 13 is a diagram in which a cathode (an upper side) and an anode (a lower side) are arranged after being extracted from a power storage element B6 according to a fifth embodiment. FIG. 14 is a diagram schematically showing a connection example of the power storage element B6 assuming an application case to a cylindrical lithium-ion battery element.

In the embodiment, a plurality of (here, three) fourth terminals 18A, 18B, and 18C connected to the load are connected to the outer periphery of the anode collector 15. Here, a case is shown in which the anode collector 15 has a rectangular main surface, the second terminal 17 is connected to one side portion among four sides forming a rectangular shape, and the fourth terminals 18A, 18B, and 18C are connected to the other side portion.

Other configurations are the same as those of the fifth embodiment and the portions corresponding to the fifth embodiment are denoted by the same reference numerals regardless of a difference in shape. In the embodiment, at least the same effects as in the fifth embodiment can be obtained.

### Example 1

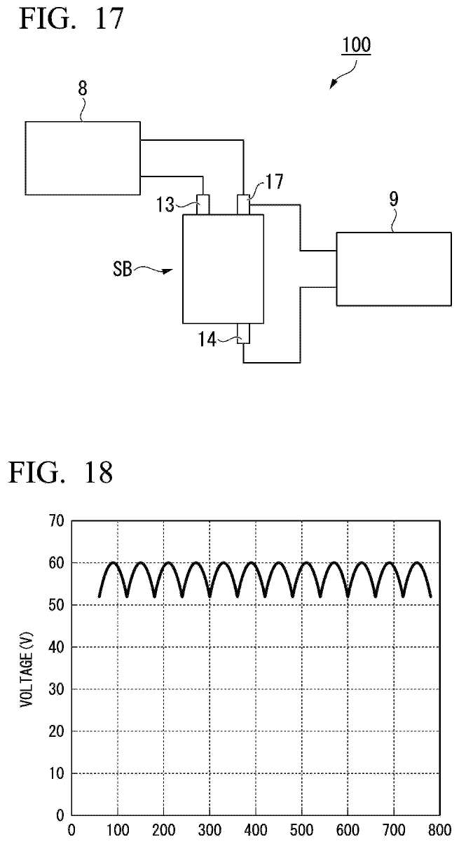

FIG. 17 is a schematic diagram of a storage power generation system according to Example 1. A storage power generation system 100 includes the power supply (the power generation element) 8, a power storage cell SB, and the load 9. The power storage cell SB includes the first terminal 13, the second terminal 17, and the third terminal 14. The first terminal 13 and the second terminal 17 of the power storage cell SB are connected to the power supply 8. The second terminal 17 and the third terminal 14 of the power storage cell SB are connected to the load 9. The power supply 8 is a power supply of which an output value varies and is, for example, a power generation element using natural energy such as a dynamo generator and a solar cell.

In Example 1, the voltage output to the load 9 was measured by using the power supply 8 as the dynamo generator. The dynamo generator includes a power generation circuit and a rectification circuit. The power generation circuit generates a three-phase alternating current and the rectification circuit rectifies the three-phase alternating current through a diode bridge.

FIG. 18 is a voltage waveform output from the power supply 8. A vertical axis denotes a voltage and a horizontal axis denotes time. As shown in FIG. 18, the voltage waveform output from the power supply 8 is a pulsating flow in which the peak voltages of the three-phase alternating current are superimposed.

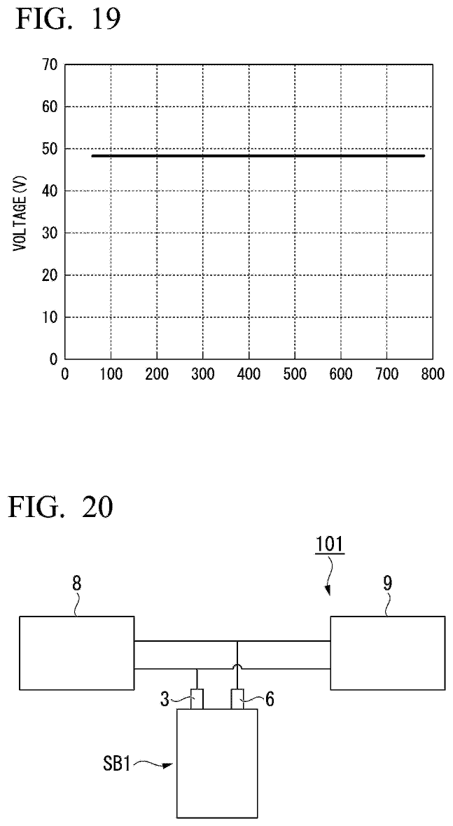

In contrast, FIG. 19 is a graph obtained by measuring a voltage output to the load 9 in Example 1. A vertical axis denotes a voltage and a horizontal axis denotes time. As shown in FIG. 19, the voltage pulsation is eliminated at a time point in which the voltage is output to the load 9. That is, the influence of the voltage variation of the power supply 8 does not reach the load 9. In the storage power generation system 100 according to Example 1, the influence of the variation of the charging voltage on the discharging voltage is suppressed although the charging and discharging of the power storage cell SB are performed at the same time. Thus, in the storage power generation system 100 according to Example 1, a converter, an inverter, a chemical capacitor, and the like for adjusting the generated voltage to a desired voltage become unnecessary.

### Comparative Example 1

FIG. 20 is a schematic diagram of a storage power generation system according to Comparative Example 1. A storage power generation system 101 includes the power supply (power generation element) 8, a power storage cell SB1, and the load 9. The power storage cell SB1 includes the cathode 3 and the anode 6. The cathode 3 and the anode 6 of the power storage cell SB are connected to the power supply 8 and the load 9.

Also in Comparative Example 1, the power supply 8 is a dynamo generator. The dynamo generator outputs a voltage waveform shown in FIG. 18. In Comparative Example 1, the battery voltage of the power storage cell SB1 was set to a minimum voltage or less output from the power supply 8.

The power storage cell SB1 is located between the power supply 8 and the load 9. A part of the power output from the power supply 8 charges the power storage cell SB1. The battery voltage of the power storage cell SB1 is a minimum voltage or less output from the power supply 8 and an excessive amount is output to the load 9.

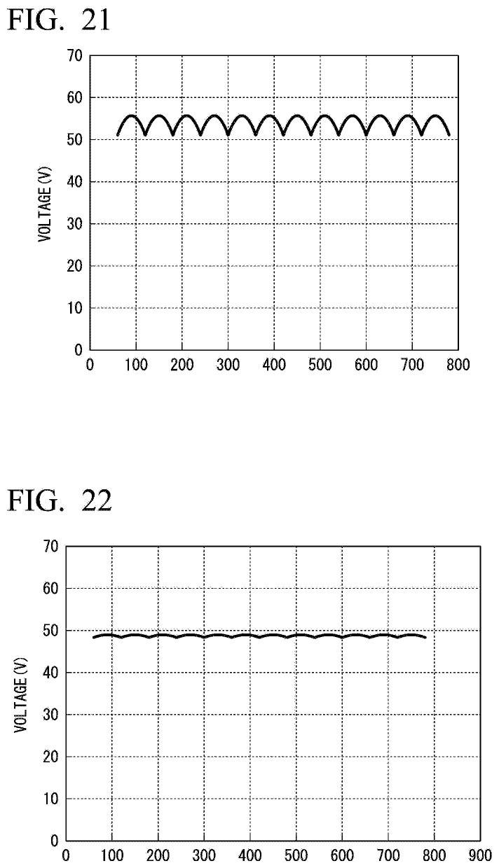

FIG. 21 is a graph obtained by measuring a voltage output to the load 9 in Comparative Example 1. A vertical axis denotes a voltage and a horizontal axis denotes time. As shown in FIG. 21, an output voltage output to the load 9 pulsates. Since a part of the power output from the power supply 8 is used to charge the power storage cell SB1, the pulsation width of the voltage output to the load 9 is smaller than the pulsation width of the power supply 8. However, the pulsation of the voltage output to the load 9 could not be eliminated.

FIG. 22 is a graph obtained by measuring a voltage output to the load 9 when the resistance value of the power storage cell SB1 is set to be higher than that of Comparative Example 1. It was assumed that the power storage cell SB1 had an internal resistance of 300 mΩ.

As shown in FIG. 22, when the resistance value of the power storage cell SB1 is changed, the pulsation width of the voltage output to the load 9 can be made smaller. However, the pulsation of the voltage output to the load 9 could not be eliminated.

### Comparative Example 2

Comparative Example 2 is different from Comparative Example 1 in that the battery voltage of the power storage cell SB1 is set between the maximum voltage and the minimum voltage output from the power supply 8. That is, in Comparative Example 2, the battery voltage of the power storage cell SB1 was set within the range of the pulsation width of the pulsating voltage.

The power storage cell SB1 is located between the power supply 8 and the load 9. When the voltage output from the power supply 8 is the battery voltage or more of the power storage cell SB1, the power storage cell SB1 performs charging and outputs an excessive amount to the load 9. When the voltage output from the power supply 8 is the battery voltage or less of the power storage cell SB1, the power storage cell SB1 performs discharging and the battery voltage is applied to the load 9.

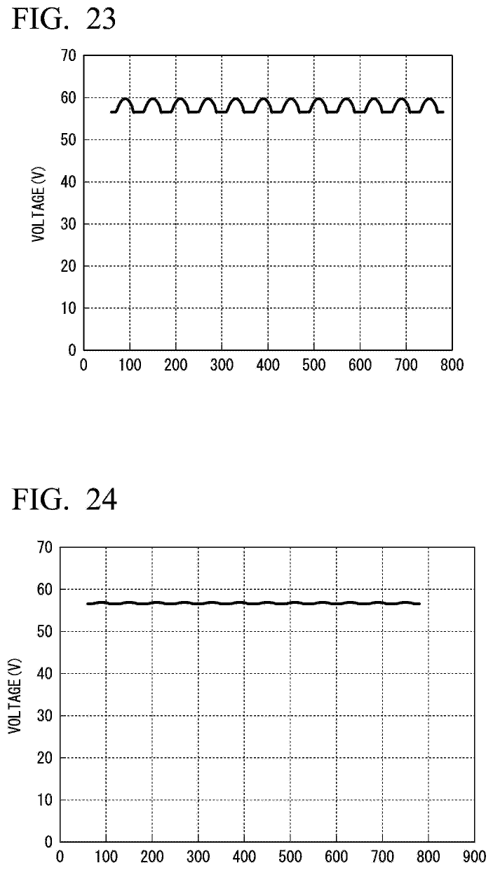

FIG. 23 is a graph obtained by measuring a voltage output to the load 9 in Comparative Example 2. A vertical axis denotes a voltage and a horizontal axis denotes time. When the voltage output from the power supply 8 is the battery voltage or less of the power storage cell SB1, the power storage cell SB1 performs discharging. Accordingly, the voltage variation does not occur. However, when the voltage output from the power supply 8 is the battery voltage or more of the power storage cell SB1, an excessively charged amount is output to the load 9, so that the voltage pulsates. Thus, also in Comparative Example 2, the pulsation of the voltage output to the load 9 could not be eliminated.

FIG. 24 is a graph obtained by measuring a voltage output to the load 9 when the resistance value of the power storage cell SB1 is set to be higher than that of Comparative Example 2. It was assumed that the power storage cell SB1 had an internal resistance of 300 mΩ.

As shown in FIG. 24, when the resistance value of the power storage cell SB1 is changed, the pulsation width of the voltage output to the load 9 can be made smaller. However, the pulsation of the voltage output to the load 9 could not be eliminated.

### LISTING OF REFERENCE NUMERALS

8 Power supply,
9 Load,
10 Switch,
1, 11 Cathode collector,
2, 12 Cathode active material layer,
3, 13, 13A, 13B, 13C First terminal (cathode),
14, 14A, 14B, 14C Third terminal,
4, 15 Anode collector,
5, 16 Anode active material layer,
6, 17, 17A, 17B, 17C Second terminal (anode),
7 Separator,
18, 18A, 18B, 18C Fourth terminal,
19A, 19B Laminate film,
20 Metal container,
21 Insulator,
22 Ring-shaped connector,
23 Insulation ring,
24 Cathode cap,
25 Insulation ring,
A, B1, B2, B3, B4, B5, B6 Power storage element, and
C Center axis.

1. A power storage element comprising:
a cathode which includes a cathode collector and an active material layer formed on a surface of the cathode collector;
a anode which includes a anode collector and an active material layer formed on a surface of the anode collector;
a separator which is interposed between the cathode and the anode;
a first terminal which is used for charging and is connected to an outer periphery of the cathode collector;
a second terminal which is used for at least one of charging and discharging and is connected to an outer periphery of the anode collector; and
a third terminal which is used for discharging and is connected to an outer periphery of one of the cathode collector and the anode collector so as to be separated from the first terminal or the second terminal.

2. The power storage element according to claim 1,
wherein each of the cathode collector and the anode collector has a rectangular main surface, and
wherein the third terminal is connected to a side of the cathode collector or the anode collector, the side being different from a side with the first terminal or the second terminal of the cathode collector or the anode collector that the third terminal is connected to.

3. The power storage element according to claim 1,
wherein the third terminal is separated by a predetermined distance or more from the first terminal or the second terminal connected to the cathode collector or the anode collector to which the third terminal is connected, and
wherein if a resistance of a region provided with the active material layer is denoted by R1 and a resistance of a region not provided with the active material layer is denoted by R1′ when the active material layer between two terminals is peeled off by a width of 0.1 mm, the predetermined distance is a distance in which a ratio of R1/R1′ is 1 or less.

4. The power storage element according to claim 1,
wherein the third terminal is connected to an outer periphery of one of the cathode collector and the anode collector and a fourth terminal is connected to an outer periphery of the other thereof, and
wherein the fourth terminal does not overlap the first terminal, the second terminal, and the third terminal when viewed from a lamination direction.

5. The power storage element according to claim 4,
wherein the fourth terminal is separated by a predetermined distance or more from the first terminal or the second terminal connected to the cathode collector or the anode collector to which the fourth terminal is connected, and
wherein if a resistance of a region provided with the active material layer is denoted by R2 and a resistance of a region not provided with the active material layer is denoted by R2′ when the active material layer between two terminals is peeled off by a width of 0.1 mm, the predetermined distance is a distance in which a ratio R2/R2′ is 1 or less.

6. A power storage cell storing a plurality of the power storage elements according to claim 1 in a battery container along with an electrolyte,
wherein each of a plurality of the first terminals, a plurality of the second terminals, and a plurality of the third terminals forms a group and is drawn to the outside of the battery container.

7. A power storage cell storing a plurality of the power storage elements according to claim 4 in a battery container along with an electrolyte,
wherein each of a plurality of the first terminals, a plurality of the second terminals, a plurality of the third terminals, and a plurality of the fourth elements forms a group and is drawn to the outside of the battery container.

8. A storage power generation system comprising:
the power storage element according to claim 1; and
a power supply which is connected to the power storage element and of which an output value varies,
wherein the first terminal and the second terminal of the power storage element are connected to the power supply, and
wherein the second terminal and the third terminal of the power storage element are connected to a load.
